(19) United States
(12) Patent Application Publication
(10) Pub. No.: US 2015/0207926 A1
(43) Pub. Date: Jul. 23, 2015

(54) ENTITY-LINKED REMINDER NOTIFICATIONS

(71) Applicant: Microsoft Corporation, Redmond, WA (US)

(72) Inventors: Jared Brown, Kirkland, WA (US); Aaron Woo, Seattle, WA (US); Robert Howard, Bellevue, WA (US)

(73) Assignee: Microsoft Corporation, Redmond, WA (US)

(21) Appl. No.: 14/162,503

(22) Filed: Jan. 23, 2014

(51) Int. Cl. H04M 1/725; H04W 4/16; H04W 4/14; G08B 21/24; H04L 12/58

(52) U.S. Cl. CPC H04M 1/72597; G08B 21/24; H04L 51/046; H04W 4/14; H04M 1/72552; H04W 4/16

(57) ABSTRACT

A computer implemented method and a mobile processing device provide reminder data in association with contact information for a known entity. A notification may be provided when communication occurs which is associated with a known entity. Communications may take the form of a phone call, an SMS message, an email, or a third-party application providing communication services. Any detectable communication in a personal computing device may trigger a reminder based on a known entity. Reminder notifications can be triggered on inbound communications and outbound communications.

### BACKGROUND

One of the many beneficial uses of “smart” mobile devices is to provide reminders based on location and time. A device user has many options for creating and triggering reminders in a mobile device. Currently, users can set reminders to trigger alerts based on location and at a specific time. Generally, reminders are text and are provided in an “alert” which overlies the smart device user interface. The alert must be disposed of before the user can continue using the device and the reminder is triggered without additional input from the user.

### SUMMARY

Technology is presented to provide reminder data in association with contact information for a known entity. When a communication occurs which is associated with a known entity, notification reminders can be provided before communication with the known entity continues. Communications may take the form of a phone call, an SMS message, an email, or a third-party application providing communication services. Any detectable communication in a personal computing device may trigger a reminder based on a known entity. Reminder notifications can be triggered on inbound communications and outbound communications. Entities can comprise individuals and groups. Reminder data included in reminder notifications can include user-entered data, data from third party applications and links to additional data accessible over a network.

In one aspect, a mobile communication device having a plurality of communication channels is provided. The device includes a number of feedback elements including a display, a speaker and a vibration element, as well as a processor and code instructing the processor to provide entity-based reminder notifications. The processor displays a user interface including an interaction region for a communication channel supported by the mobile communication device on the display. When a communication from a known entity is conducted via a communication channel supported by the communication device, a determination is made as to whether the known entity has at least one reminder associated with the known entity. If so, a notification of the reminder including reminder data is displayed in a user interface with data from the communication.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a flowchart illustrating a general method for implementing the present technology.

FIGS. 2A-2C depict a user interface for a smart processing device illustrating various displays of reminders and reminder selection interfaces;

FIGS. 3A-3E illustrate a set of user interfaces depicting the creation of a people linked reminder.

FIG. 3F illustrates an alternative user interface which may be used to input reminder data in accordance with the present technology.

FIG. 4A illustrates a user interface depicting a mobile device reminder for text reminder data when a user receives a phone call.

FIG. 4B illustrates a user interface depicting a mobile device reminder for inked reminder data when a user receives a phone call.

FIG. 4C illustrates a user interface depicting a mobile device reminder for text reminder data when a user is engaged in an SMS message.

FIG. 5A illustrates a user interface depicting a mobile device reminder for text reminder data when a user receives an email message in an inbox.

FIG. 5B illustrates a user interface depicting a mobile device reminder for text reminder data when a user interacts with an email message.

FIGS. 6A-6B illustrate a second user interface depicting a reminder interface engaged when a user takes action to view a reminder during a telephone call.

FIGS. 7A-7E Illustrate telephone communication user interfaces including creating a reminder following completion of a telephone call.

FIG. 8 illustrates a flowchart of a method of the present technology.

FIG. 9A is a flowchart illustrating a first method for polling communication channels in a mobile device and displaying a reminder accordingly for an inbound communication.

FIG. 9B is a flowchart illustrating a method for polling inbound communication events on communication channels in a mobile device displaying a reminder interrupting an active interface with a reminder notification for messaging applications.

FIG. 9C is a flowchart illustrating a method for polling communication channels in a mobile device displaying a reminder accordingly for an outbound communication.

FIG. 10 is a block diagram illustrating a mobile processing device.

FIG. 11 is a flowchart illustrating a method of retrieving reminder data from communications.

FIG. 12 is a flowchart illustrating a method of linking network accessible data in reminder data for use in a reminder notification.

FIGS. 13A-13F illustrate user interfaces suitable for use with the method illustrated in FIG. 12.

### DETAILED DESCRIPTION

Technology is presented to provide reminder data in reminder notification which are associated with contact information for an entity. Such “people” based reminders allow for triggering a reminder notification on a personal computing device such as a mobile phone when an activity, such as a communication using one of the communication channels available to the personal computing device, occurs which may be associated with a known entity. Known entities may be identified by a contact record stored in the personal computing device. Communications may take the form of a phone call, an SMS message, an email, or a third-party application providing communication services. Any detectable communication in a personal computing device may trigger a reminder based on a known entity. Reminder notifications can be triggered on inbound communications and outbound communications. Entities can comprise individuals and groups.

Each communication channel may be accessed on the device by a communication user interface. A telephone call is accessed through a communication user interface comprising a telephone interface. Messaging applications using a messaging channel (a messaging communication channel) such as an SMS application and an email application provide communication user interfaces which are messaging user interfaces allowing interaction with the SMS communication channel and the email communication channel. Third party applications may provide other types of communication user interfaces for other communication channels.

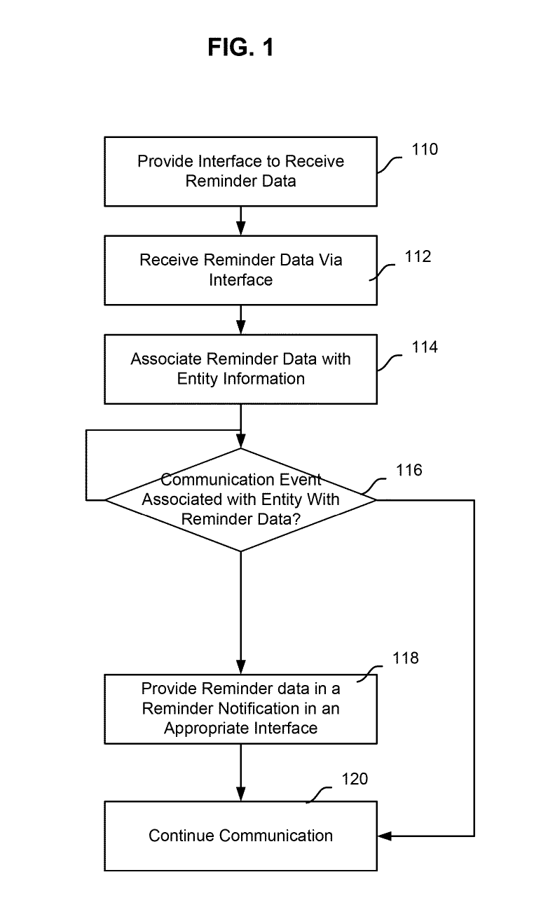

FIG. 1 is a flowchart illustrating a general method in accordance with the present technology. In general, communication activity by a processing device, such as a mobile processing device, that is associated with an entity can trigger a reminder notification associated with the entity. At 110, an interface is provided to receive reminder data. Reminder data comprises any data which may be associated with an entity and which may be displayed in a reminder notification triggered by a communication event with a known entity. In one embodiment, the interface is a user interface associated with a personal computing device such as a mobile phone. The user interface allows a user to manually input reminder data to be provided in a reminder notification. In an alternative embodiment, the interface is an application programming interface allowing third parties to connect third-party applications to provide the reminder data to be used in a reminder notification. At 112, reminder data is received via the interface. The reminder data can be any number of different types of data, including text, an ink note, a photograph, a recording or any information which may be collected by the personal computing device. Similarly, an application programming interface may be utilized to receive such various different types of data from third parties or third party applications. At 114, the reminder data is associated with entity information for use in generating a reminder notification based on a communication activity. In one embodiment, entity information is stored in a “contact” record identifying the entity to one or more users of the personal computing device. Once the reminder data is associated with an entity, at 116, a determination is made as to whether or not a communication has been initiated which is associated with the entity which has reminder data. If not, then the communication continues at 120. If so, the reminder data is provided in a reminder notification in an interface appropriate to the communication at 118, as described below.

Various examples of the interfaces which may provide reminders are disclosed herein. While a number of descriptions of reminder notifications are discussed with reference to a visual reminder notification, many personal computing devices include speakers and vibrations mechanisms that may be utilized in conjunction with a visual indicator when a reminder notification is provided.

The communication event which triggers an entity based reminder notification may be an inbound communication or an outbound communication. The personal computing device may have any number of different communication channels including, for example, a telephone channel, a SMS channel, and an email channel. Other types communication channels, such as those provided by third party applications through various different types of voice communication or data messaging applications, can also be considered communication channels within the context of the present technology. A communication associated with the communication channel trigger an event to determine whether or not the truncation is from associated entity. In one embodiment, if a communication channel generates an event associated with the communication—such as a phone call—that event is used to trigger a determination as to whether the communication is from a known entity and to determine whether to fire a reminder notification. Where the communication is through a channel which may not generate an event which interrupts other aspects of an operating system on the processing device—such as for example an SMS—a polling agent can monitor instances of communications on such channels and determine whether to generate a notification. Reminder notifications can be provided in the interface and/or using any of the audio/visual capabilities of the personal computing device, including, but not limited to a visual display of a notification reminder, a sound, a vibration and the like.

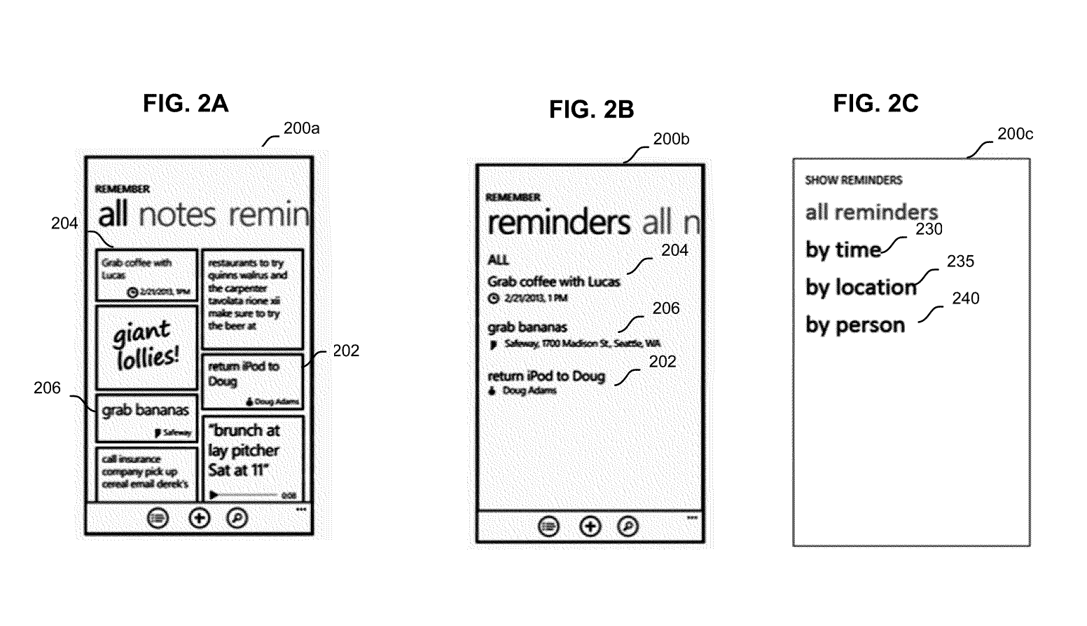

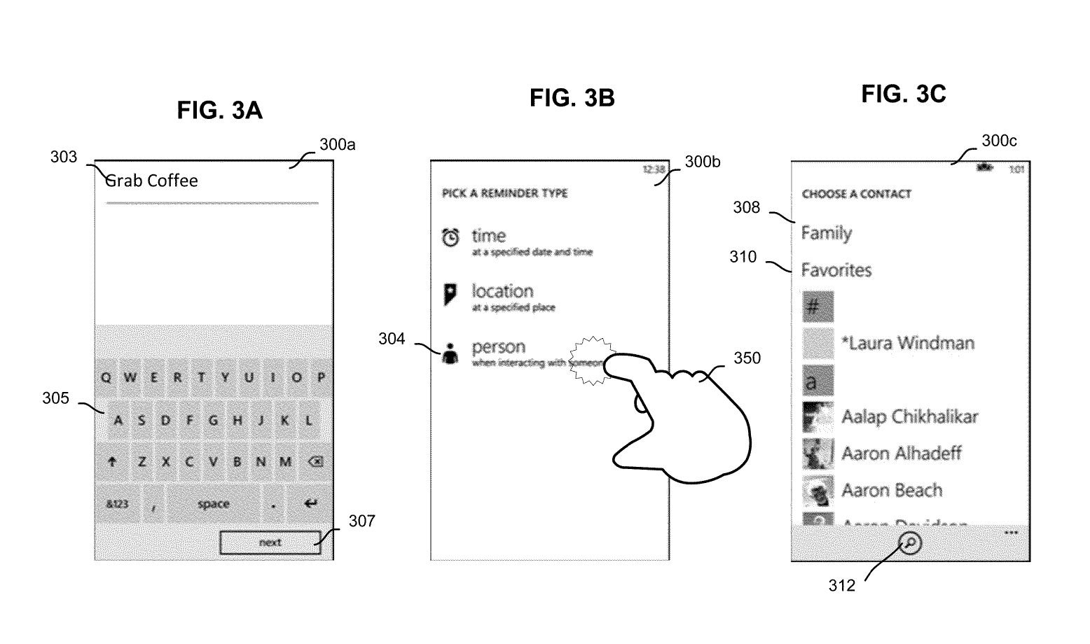

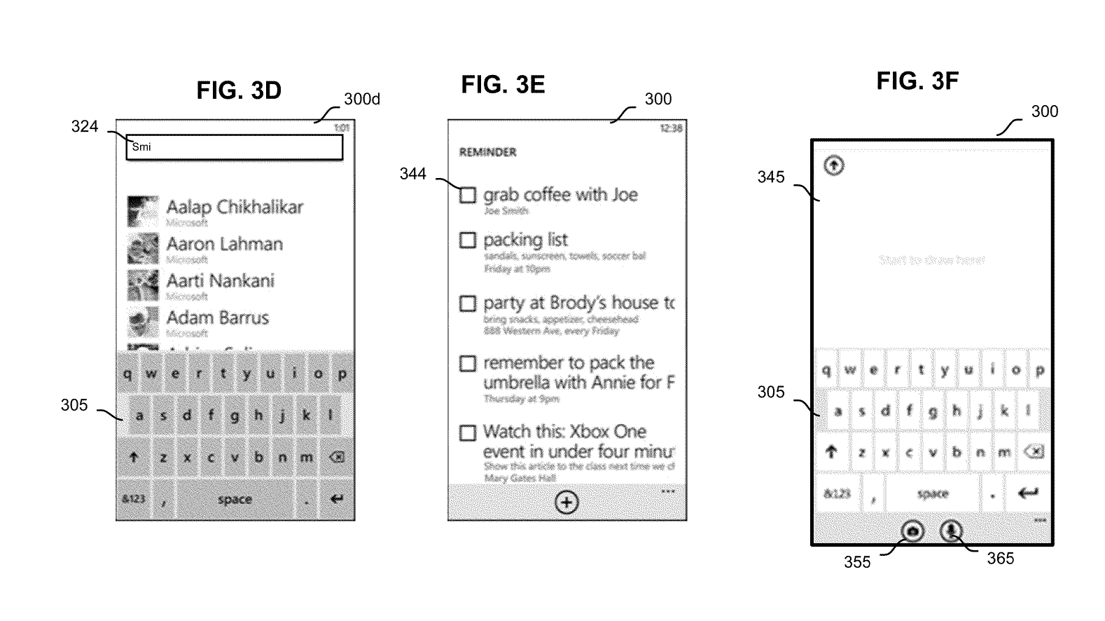

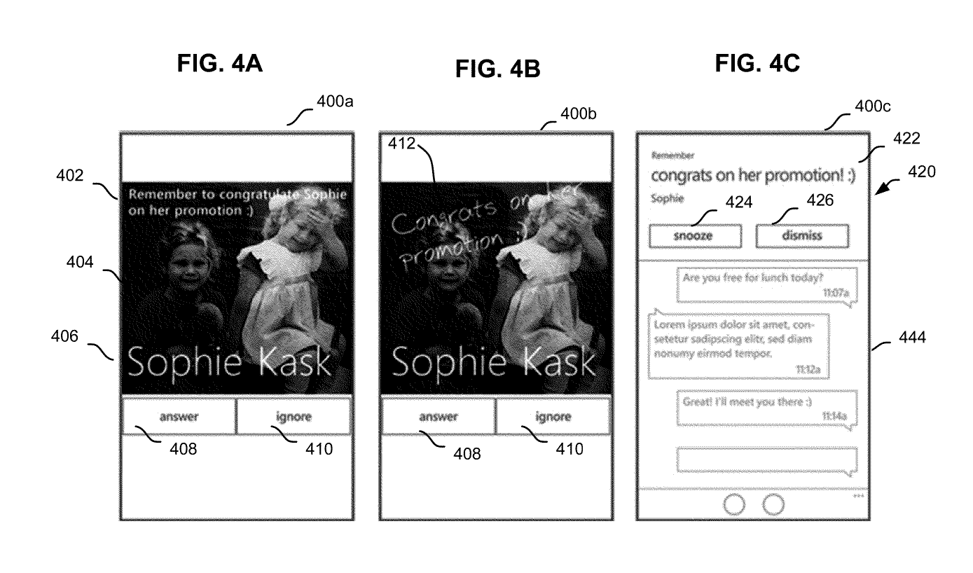

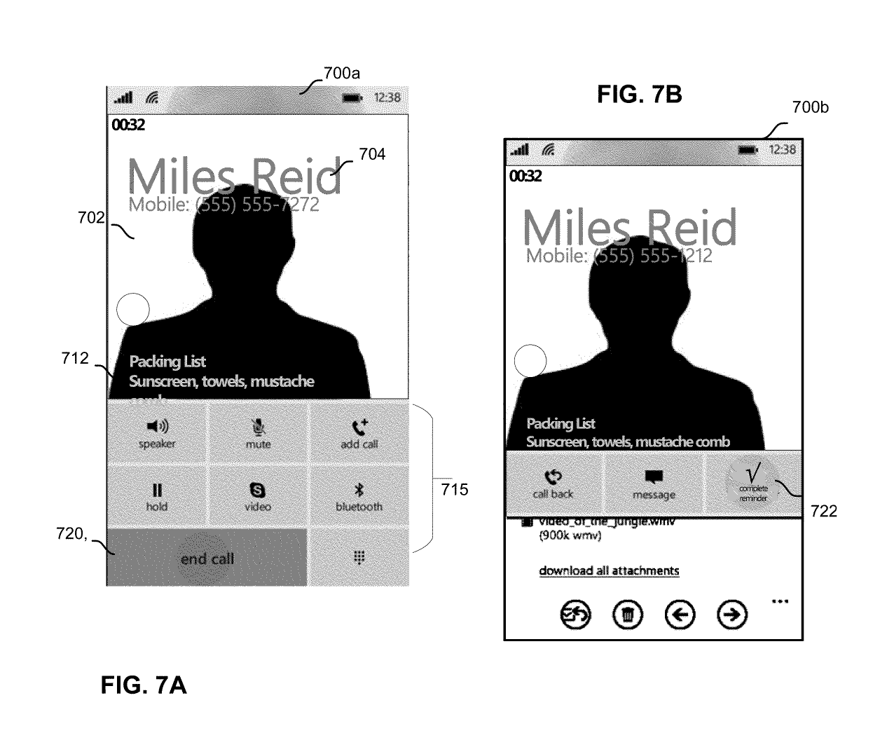

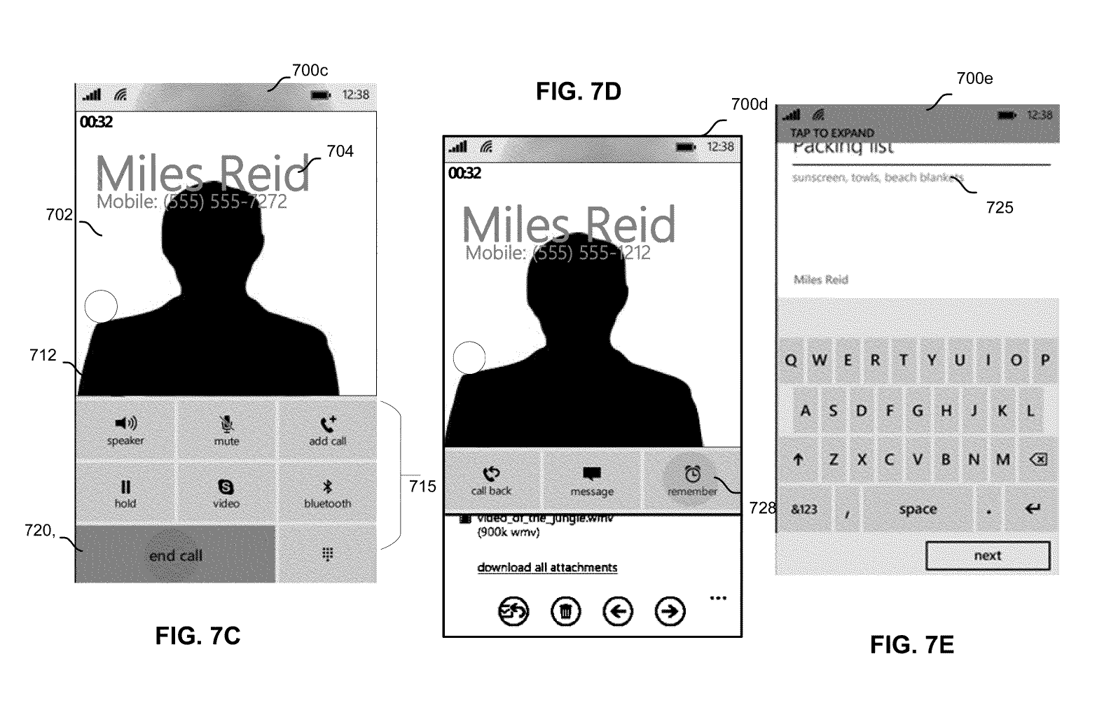

FIGS. 2A through 2C illustrate various user interfaces for displaying reminder data in a personal computing device such as a mobile phone. FIGS. 2A-2C illustrate initial screens in an interface when no specific communication with a known entity has been triggered. FIGS. 3A-3F and 7C-7E illustrate interfaces for the creation of entity based reminders, while FIGS. 4A-7B illustrate various types of reminder notifications.

The interface examples of FIGS. 2A-2C illustrate that reminder data may be displayed with an association to known entity in interfaces in forms other than reminder notifications triggered by communication events. One type of user interface for a mobile phone includes the tiled interface available in the Windows Phone operating system available from Microsoft Corporation, Redmond Wash. This type of interface includes “active” or “Live” tiles which display information from various data sources within the display area of the personal computing device. Illustrated in FIG. 2A is a set of tiles including both reminder information as well as other information stored by the mobile device. Other types of reminder notifications, including modal alert dialogs and overlay notifications, are displayed below and utilized based on the communication user interface and communication channel in use.

FIGS. 2A through 2C illustrate a first embodiment of a user interface 200 showing entity based reminders in tile and list form, as well as other types of reminders. Entity based reminders may be displayed in any number of different user interfaces. FIG. 2A illustrates a user interface 200a with an entity reminder 202 displayed in a tile along with a number of other tiles providing other types of reminder information including, for example, a time-based reminder 204 and a location-based reminder 206. Reminder data associated with the notification is displayed. A time-based reminder displays a reminder notification on a computing device interface at a particular time. A location-based reminder generally displays a notification of the reminder data when the user is detected as being at a particular location.

As illustrated in FIG. 2A, the type of data which may be associated with all types of reminders and notes can comprise text, an ink note, an audio note, a recording and/or a picture, or any audiovisual content stored in the personal computing device. Still further, reminder data may include links to 3^{rd} party content or content available in 3^{rd} party applications. The type of reminder data which may be associated with a reminder is limited only by the capabilities of the personal computing device used to capture such data. Once captured, the reminder data can be associated with known entity information, as described herein.

Is illustrated in FIG. 2C, a user can further select to display only one category of reminders, such as, for example, reminders by time 230, by location 235, or by person 240.

It should be understood that the nomenclature of “person” and “people” are used to identify contact information associated with an entity. As such, a “person” can comprise any stored contact information for any type of entity, including people, businesses or corporate entities.

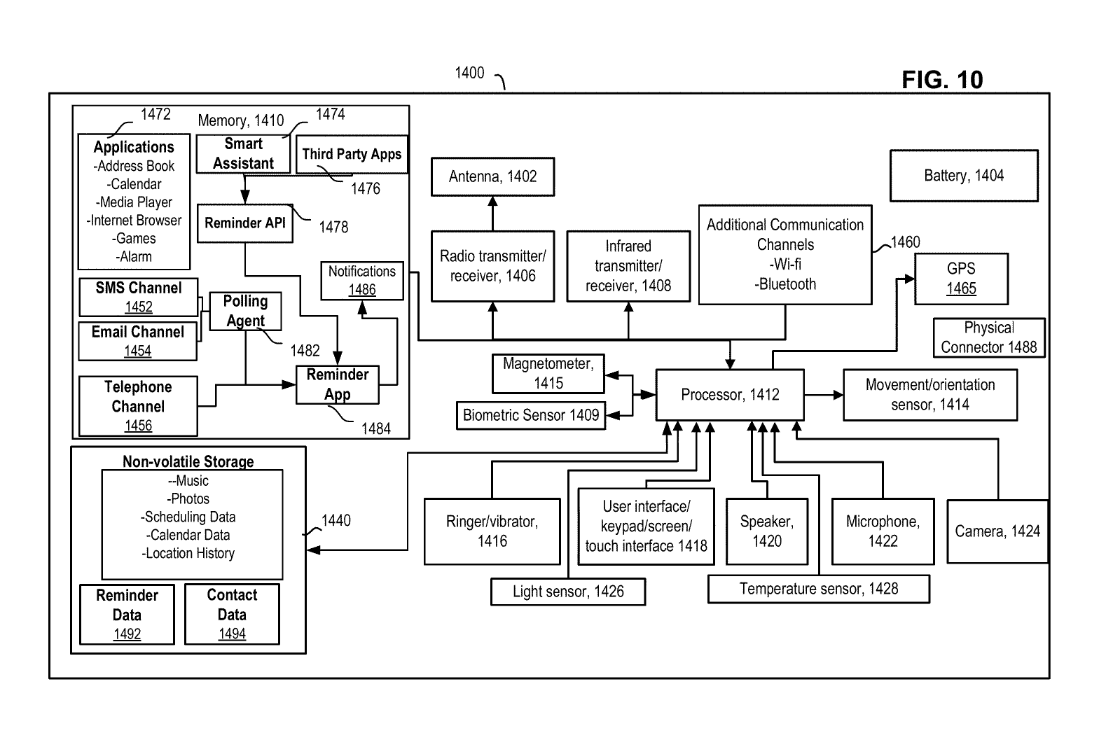

FIG. 2B illustrates an list display interface 200b which lists three types of reminders illustrated in FIG. 2A. In FIG. 2A, the reminders are combined with other types of data stored in the personal computer devices, such as, for example, notes and calendar information. In FIG. 2B, three different types of reminders are illustrated in a list format. In accordance with the technology, various types of user interfaces may be utilized. The user interface of FIG. 2B, the user may select the “reminders” menu item, which sorts and displays only the reminder data stored in the personal computing device. A suitable personal computing device for use with the present technology is illustrated in FIG. 10.

FIGS. 3A through 3F illustrate various interfaces and methods of inputting reminder data into a personal computing device utilizing a user interface. The reminder data is used in creating reminder notifications which are displayed in the context of the communication occurring on the processing device. (FIGS. 4A-6B, 7A and 7B illustrate various types of reminder notifications.)

The user interfaces illustrated in FIGS. 3A through 3F are merely exemplary. FIG. 3A illustrates a mobile device interface 300a which provides providing a keyboard 305 and a text entry area 303. In FIG. 3A, the user is entering text “grab coffee.” FIG. 3A, once the user has entered the appropriate reminder data, in this case “grab coffee”, the user selects a “next” button 307 and is directed to a “pick a reminder type” screen 300b, illustrated in FIG. 3B. The type of reminder may be selected by selecting the “person” entry on the reminder type screen using, for example, a touch screen interface where a user hand 350 selects the “person” entry. Selecting the person entry directs the reminder data to be associated with entity information. When a user selects to enter an entity reminder by selecting the “person” menu item, the user may be presented with an interface 300c to allow the user to choose a contact as shown in FIG. 3C. Entities can be organized into groups such as “family” 308 and “favorites” 310. Interfaces offer also provided with a search function accessible through a button 312 provided in the interface. In the user interface 300c, entity information can be selected by a user “touching” one of the contact entries. The interface 300c allows a user to scroll through entries in the contact data of the user in a known manner.

Optionally, a user may select to search the contact data by selecting button 312. If a search is selected, an interface 300d such as that shown in FIG. 3D is provided. A keyboard 305 allows a user to enter search text in field 324 to select the particular contact with which the reminder data entered in FIG. 3A is to be associated. FIG. 3E illustrates the resulting reminder entry 344 along with a list of other reminders which have been previously entered into the mobile computing device. The entry includes reminder data “get coffee” along with the entity association of “Joe Smith.”

FIG. 3F includes a number of different types of data entry fields including an ink or freehand drawing field 345 entry field allowing user to draw or enter text using a keyboard or freehand entry. Two menu items allow a user to access the processing device camera application at 355 and a voice recording application at 365. The user can enter photographic data by selecting to access the mobile processing devices camera or recorded entries by selecting to access the recording application.

FIGS. 4A-4C illustrate different types of reminder notifications which may be provided on receipt of a phone call and SMS message. It should be recognized that although the description discusses reception of phone calls, reminders can be provided when a user initiates a phone call, initiates an SMS message, or initiates an email.

User interface 400a shown in FIG. 4A illustrates a reminder notification comprising reminder data provided along with contact information for an incoming phone call from a known entity. The reminder notification is provided as an overlay to a phone call notification, and provides limited actions which can be used on the reminder notification. It should be understood that the term “phone call” can include any type of voice communication including but not limited to a cellular network call or a voice over IP (VOIP) communication. Standard caller identification techniques may be used to associate the caller's telephone number with the known entity information. The contact data for the entity may provide a picture 404 and contact name 406 that are displayed when the call is received. The user interface provides an answer key 408 or an ignore key 410 to take respective answer and ignore action in relation to the phone call. In one embodiment, a reminder notification 402 including reminder data is displayed in the form of text relative to the calling party. The text is displayed in an area allowing the user full access to controls for the call as well as the identifying information for the entity.

FIG. 4B illustrates the use of ink data in relation to the calling entity. Interface 400b shows that the reminder data 412 comprises a handwritten note that the user has associated with the entity. Again the reminder data is provided in a notification in a display region of the user interface apart from an action region (answer key 408 and ignore key 410).

FIG. 4C illustrates a reminder notification 422 displayed in an SMS application 444. Notification 422 is a modal alert dialog prompting user interaction with the notification before the user can proceed with the SMS conversation. In an alternative embodiment, the alert 422 need not require user input but may be configured to disappear when the user touches an area of the interface outside of the dialog. The reminder notification 422 includes the reminder data, the name of the contact as well as options to snooze 424 and dismiss 426 the reminder notification 422. In this example, the notification 420 is provided while the user is engaged in the conversation mode of the SMS application. In other alternatives, the notification can be provided when an SMS message is received and the user is not in the SMS application. The reminder notification format may be utilized with other types of messaging applications, including, for example MMS. E-mail and any 3rd party app experience as well.

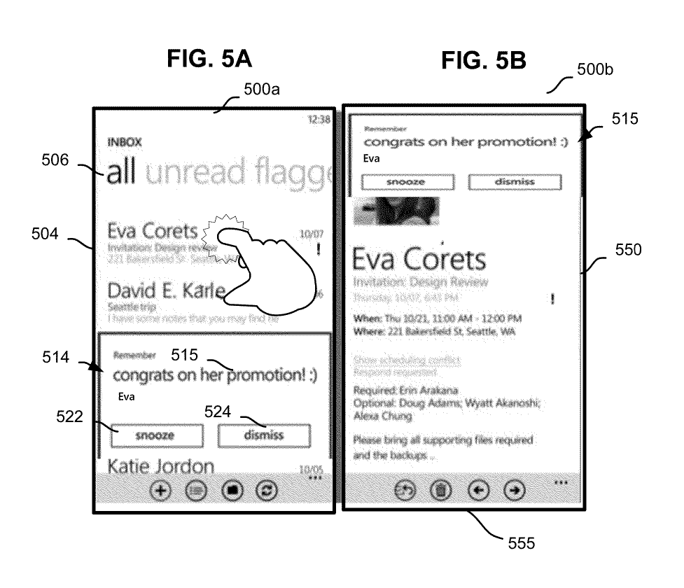

FIGS. 5A and 5B illustrate the display of a reminder notification in an email application. In FIG. 5A, user interface 500a a shows a user email inbox on a user interface. The user can select display all, unread, or flag messages using the menu options at 506. A snippet of each email in the inbox view is displayed by username and title at 504. When a new email such as indicated by snippet 504 is received, a reminder notification window 514 shows the reminder data 515 as well as options to snooze 522 and dismiss 524 the reminder notification. Once again, the user can select the message by touching the user's name, resulting in a display of the message such as that shown in user interface 500b. As illustrated in FIG. 5B, the notification reminder data 515 is provided in a display area allowing the user to interact with the message display 550, including allowing the user to interact with the messaging application. Typical messaging application functions such as reply and trash, as well as options to select the next message, are provided in menu 555. The user can choose to interact with any of the reminder window 514 or the message display 550, or the menu 555.

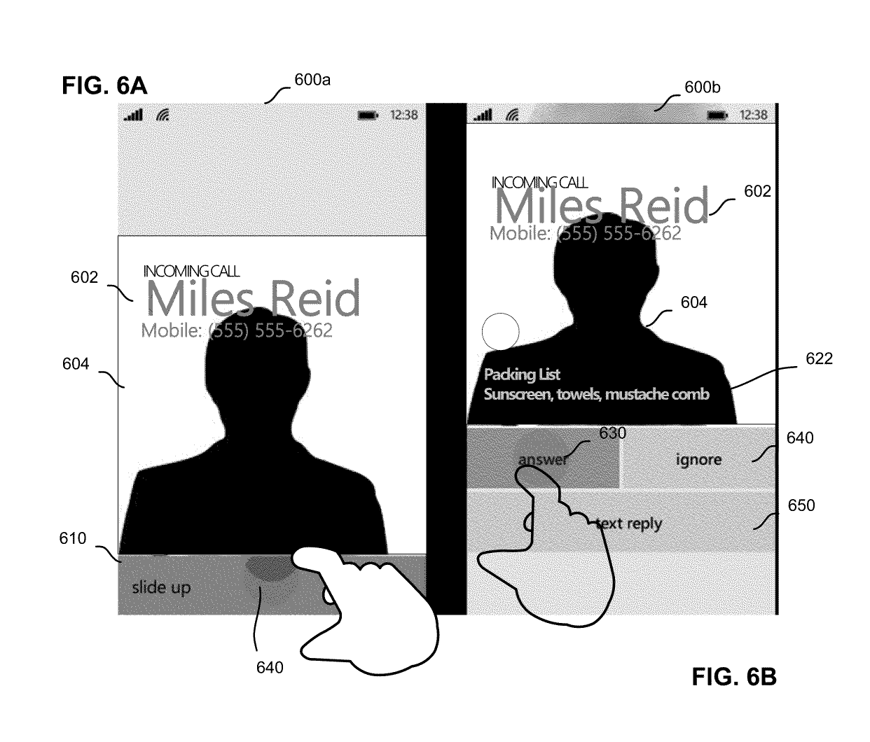

FIGS. 6A and 6B illustrate a second embodiment of the provision of an entity-linked reminder notification when a user receives a phone call from a known entity. As illustrated in FIG. 6A, in an interface 600a, a user receives a phone call from the contact indicated by text 602 and photo 604. The user does not have to engage the call, but if the user chooses to do so, in interface 600a the user is prompted to “slide up” (610) by touching button 640 and swiping upward while engaged with the display. User may be presented with a menu option 606 and prompts text 608 prompting the user to quote slide up the user wishes to view reminder information about the calling entity. When user slides up, the interface 600b is presented as shown in FIG. 6B. The reminder information 622 (reminder data) is presented in the display region above the active region which includes phone call interface buttons to answer the phone call at 630, ignore the phone call at 640, or provide text reply at 650. The reminder does not appear until the user slides up to begin interacting with the phone call. Note the user does not have to answer for the reminder user interface to appear. The reminder text can be visible on the incoming call screen above lock.

FIG. 7A-7B illustrate a user interface allowing a user to modify reminder data associated with an entity when a user is engaged in a phone call. (In one embodiment, this occurs after a user selects the “answer” key 630 shown in FIG. 6B.) While in the call, the reminder can be followed for further interaction. That is, tapping the reminder text opens the item. Changes to the item if changed during the present call may or may not be reflected in the current phone call. As illustrated in FIG. 7A, user interface 700a shows the entity contact information via a picture 702 and name text 704. In addition, the reminder information 712 is displayed overlaid on the contact information. An in-call menu 715 allows the user to transfer the call to a speaker, mute the call, add additional callers, placed a call on hold, transfer to a video service, or transfer to a Bluetooth connected device. The user can also end the call or bring up a numeric keypad. When a user selects to end the call by selecting button 720, the interface presented is interface 700b in FIG. 7B. In interface 700b, the user is presented with options to call the previous user back, message the previous user and complete a reminder at 722. Completing a reminder can mark the reminder as “completed” and or allow other actions on the reminder.

FIG. 7C illustrates an in-call interface 700c when no reminder is associated with the calling party. When a user selects to end the call as illustrated in FIG. 7C, the interface 700d of FIG. 7D may be presented offering the user the options to call the previous user back, message the previous user and create a reminder at 728. If the user selects the create reminder button 728, the interface 700e of FIG. 7E is presented. The interface links the previous entity with which the processing device was engaged in a communication, any previous reminder text 725, and keyboard allowing the user to alter the text which comprises the reminder data. In yet another embodiment, completing a reminder may provide an option to append or edit an existing reminder (shown in FIG. 7b in interface 700b) which would lead the user to interface 700e to add to the reminder data previously associated with the entity.

It should be recognized that in an alternative embodiment, reminder data may be entered and associated with an entity when engaged in a communication with the entity. For example, when engaged in a phone call with a known entity, a “remember” entry may be added to the interface 700c which generates a display similar to interface 700e (FIG. 7E) to add reminder data associated with an entity when engaged in a phone call.

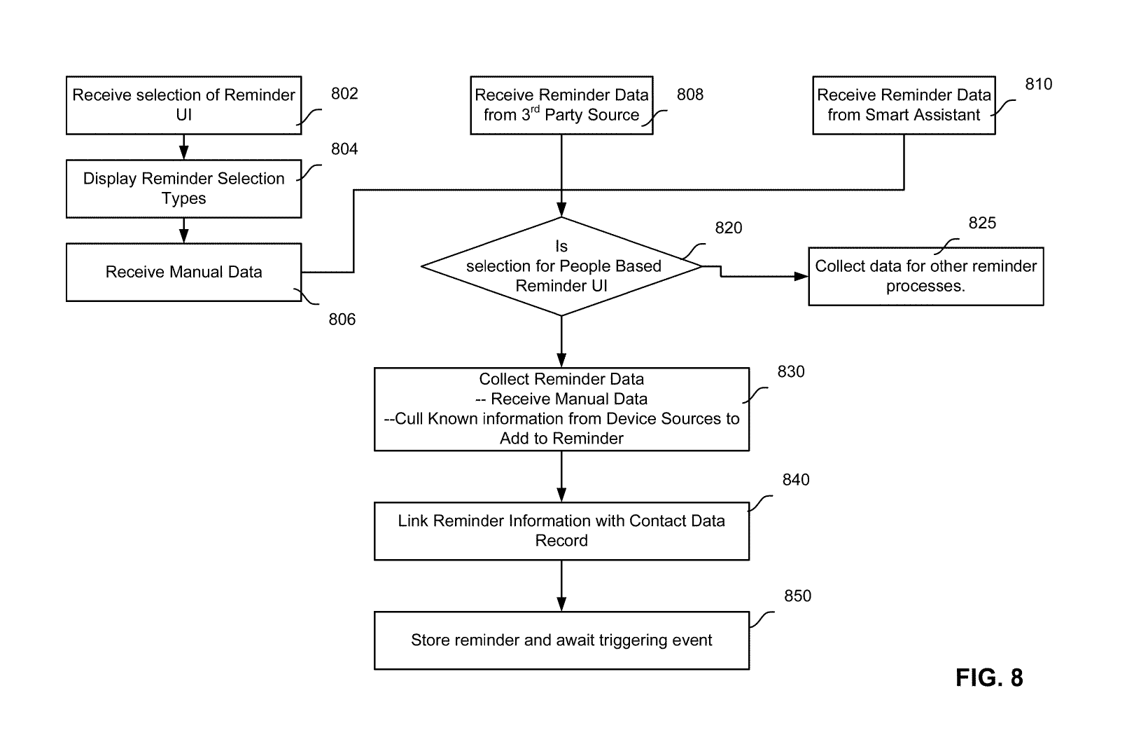

FIG. 8 illustrates a method for associating data with a known entity. Reminder data—information to be displayed in a reminder notification—can come from any of a number of different sources. In some cases, reminder data may be input by a user manually. At 802, a selection of a reminder user interface may be received by the processing device. At 804, reminder selection types may be displayed. One example of this display is set forth above in FIG. 3B. At 806, user entry of reminder information is retrieved. One example of a user interface receiving user input for a reminder is shown in FIG. 3A. As noted with respect to FIGS. 3A and 3B, steps 806 and 804 may be reversed. In other embodiments, reminder information may be received from a third party source via a communication with an application programming interface in the processing device. At 808, a set of reminder data may be received from a third party source. In still another embodiment, at 810, reminder data may be received from a smart assistant. A smart assistant is a personal information application responsive to voice input which utilizes data in the processing device to respond to user commands to enter and retrieve data. A voice command of, for example, “get coffee with Joe Smith” may generate an entity linked reminder of text “get coffee” with a link to entity information stored in a contact data for Joe Smith in a contact database on a processing device. At 820, a determination is made as to whether not the selection of the reminder is for an entity-linked reminder. If not, the data may be transferred to a process 825 for a location or time based reminder. If the selection is for an entity based reminder at 820, then the reminder data is collected at 830 from one of the sources noted above in steps 802-810 and culling additional known information from the device data sources to add to the reminder. At 840, reminder information is linked with the entity contact record in a contact data store, discussed below with respect to FIG. 10. At 850, the reminder in the contact record are stored in a way a triggering event. As explained herein, a triggering event may comprise an outbound or inbound communication on one of the communication channels available on a processing device.

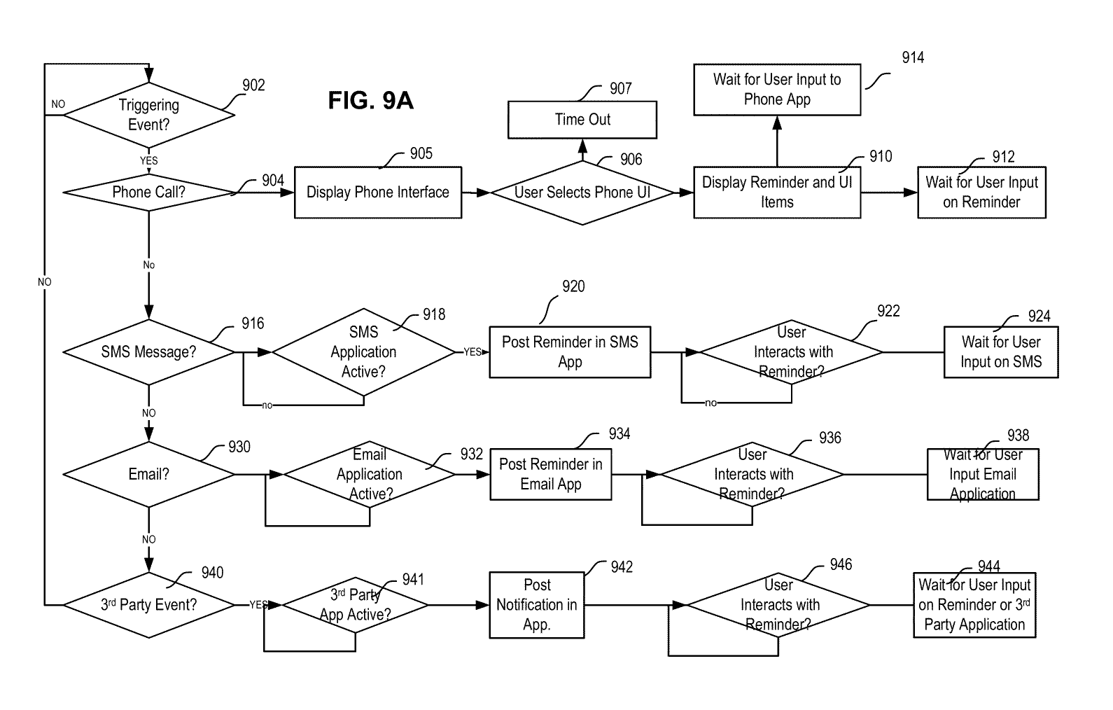

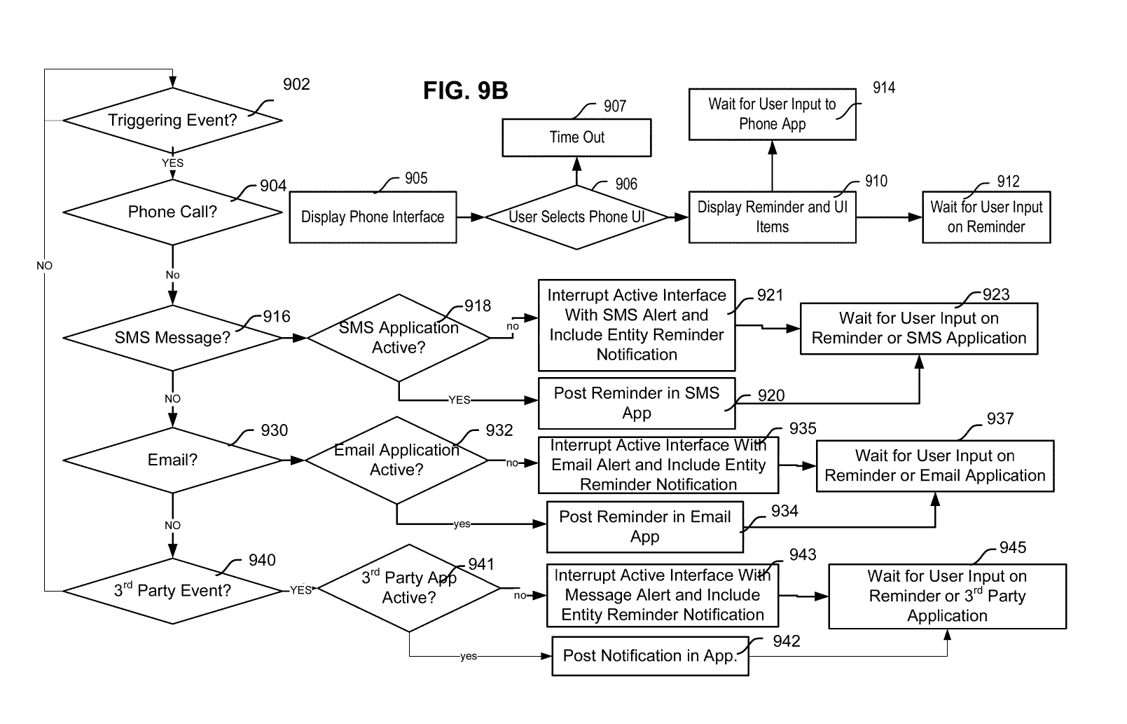

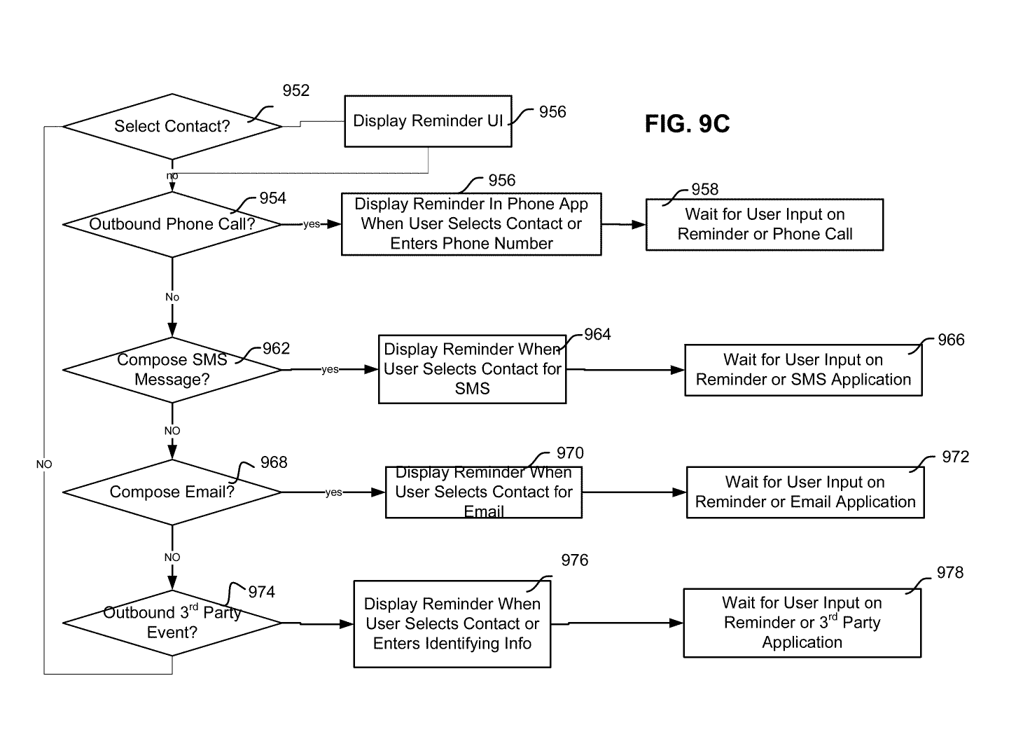

FIG. 9A illustrates a flowchart of a method for determining whether to display a notification reminder based on the state of the processing device when an inbound communication is received. Initiating a communication by the communication device as a triggering event is illustrated in FIG. 9A. An alternative method of displaying a reminder notification where a communication application is not active is illustrated in FIG. 9B. A triggering event where generated by a user is illustrated in FIG. 9C. In each instance of FIGS. 9A and 9B, it should be noted that reminder data is associated with an entity. If no reminder data is associated with an entity, or if a reminder was associated with an entity and dismissed, no reminder notification is provided

At 902, in initial determination is made as to whether not a triggering event has occurred. The triggering event can be the initiation or receipt of a communication on a communication channel supported by the processing device. If a triggering event occurs, then at 904, 916, 930 and 940, actions are taken depending on the type of triggering event which occurs. If the triggering event is a phone call at 904, then at 905, the phone interface displaying a calling party is displayed and at 906, a determination is made as to whether not the user has selected to interact with the phone interface. As illustrated above, in one embodiment, the user must slide upward in the user interface to view the reminder data associated with an incoming phone call. If user selects to view the reminder, then the reminder notification is displayed along with the reminder data at 910. The user does not select to view the reminder, then the device waits for input to the user phone call at 914. If not, the call times out at 907. If the user interacts with the interface by, for example, sliding the user interface upward (as in FIG. 7A) the reminder notification is displayed and the method wait for user input on the reminder at 912 or to the phone app at 914. After input on the reminder, input to the phone app or if the call goes unanswered and the method waits for the next inbound triggering event.

If the triggering event is an SMS message at 916, then a determination is made at 918 as to whether not the user is already engaged in the SMS application. At 918, the method waits until the SMS application becomes active before an entity reminder notification will be displayed. If the SMS application is active, (and reminder data for the entity exists,) a reminder notification is displayed in a display area within the SMS application in accordance with any notification settings for the SMS application at 920. At 922, the method waits for input to the reminder notification and once the reminder is addressed at 922, input to the SMS application can proceed at 924.

If the triggering event is an email at 930, a determination is made at 932 as to whether not the email application is active. If the email application is not active, the reminder notification is held until it becomes active at 932. Once active, at 934 the reminder notification is posted in a notification area at 934, examples of which are illustrated above. At 936, the method waits for input to the reminder notification before allowing input to the email application at 938

If the triggering event as a third-party application event at 940, then a determination is made at 941 as to whether the 3^{rd} party application is active. If so, then the reminder is posted in a notification view area at 942 in accordance with the settings for the 3^{rd} party application notifications. In one embodiment, the notification waits for user interaction at 946 and once the notification interaction occurs, user input on the 3^{rd} party application occurs at 944.

In one instance, as illustrated in FIG. 9A, the reminder notifications are displayed in the message interfaces of the SMS application, email application or 3^{rd} party application, providing the reminder notification with context—the reminder notification is s related to the item the user just opened because the addressee or sender is the entity about which the reminder triggered.

Note that for SMS messages, Emails and 3^{rd} party applications, the processing device interface may provide an alert that the message has been received apart from the notification reminder. These message alerts are not reflected in FIG. 9A. Such notifications may or may not interrupt any current activity occurring in an interface on the processing device, depending on the configuration of the device interface. As discussed below with respect to FIG. 9B, in one alternative, this message alert may be joined with an entity reminder notification. For purposes of this description and in the embodiment of FIG. 9A, however, the SMS/Email/3rd Party application alert does not include an entity reminder notification.

FIG. 9B illustrates an alternative embodiment of the method wherein notifications can be provided even if the communication channel application (the SMS application, email application or 3^{rd} party application) is not active. Steps illustrated in FIG. 9B having the same reference numbers as those in FIG. 9A are equivalent to those in FIG. 9A. As such, the phone interaction notification steps 904, 905, 906, 907, 910, 914, and 912 are equivalent to those in FIG. 9A.

If the triggering event is an SMS message at 916, then a determination is made at 918 as to whether not the user is already engaged in the SMS application. If the SMS application is already active, (and reminder data for the entity exists,) a reminder notification is displayed in a display area within the SMS application 920. If not, an SMS alert may be displayed interrupting the interface then in use on the device on receipt of the SMS message at 921 in accordance with any notification settings for the SMS application. Many processing devices capable of providing communication channels such as SMS, Email and third party application allow setting of notifications when activity on such channels occurs. In the embodiment of FIG. 9B, reminder notifications are displayed with the message alerts according to alert settings for such communication channels. For example, if a new SMS is set to display a new SMS alert immediately on receipt of a new SMS message, then the reminder notification may accompany the new SMS in an overlay on the interface (at step 921). If a new SMS message does not generate an alert, no reminder notification is displayed until such time as an SMS notification would be displayed. At 923, the method waits for input to either the SMS application or the reminder notification. Input to the SMS alert which effectively ignores the reminder can have the effect of snoozing the reminder until the next communication event relative to the known entity.

If the inbound triggering event is an email at 930, a determination is made at 932 as to whether not the email application is active. If the email application is active at 932 and the remainder notification is posted in a notification area at 934, examples of which are illustrated above. If the email application is not active, an email alert may be posted at 935 in accordance with the alert settings of the processing device and the entity reminder notification is posted in a notification view area appropriate to the notification settings in use. In both cases, the method waits for input on the reminder and the email application at 937.

If the triggering event as a third-party application event at 940, then a determination is made at 941 as to whether the 3rd party application is active. If so, then the reminder is posted in a notification view area at 942 in accordance with the settings for the 3rd party application notifications. If the third party application is not active, then at 943 an alert may be presenting in accordance with the alert settings for the processing device and an entity notification is posted with the alert. Action on the notification or the 3rd party application occurs at 945.

FIG. 9C illustrates a situation where the triggering event is an outbound communication. For an outbound communication, the user may begin by selecting a particular entity with which the communication is to be initiated at 952. In many contact applications, links are provided when a user selects a contact record to initiate a communication directly from the contact record. The link can activate a telephone call, an email or an SMS. Alternatively, the user may activate an application which uses the communication channel before selecting a contact. If the user decides select contact 952, then the reminder notification may be displayed on selection of the contact at 956. If an outbound phone call is initiated by activating the telephone application at 954, the reminder is displayed in the view area of a phone application at 956 when the user selects the contact in the phone application or enters identifying information, such as the user phone number. At 958, the system waits for user input on the phone call. Similarly, SMS application is activate at 962, a reminder is displayed when a user selects a contact at 964 and user input is determined at 966. At 968 if user initiates an email composition, a reminder notification is displayed when a contact is selected for receipt of the and at 972 the system waits for user input on the reminder or the email action. If a third party application is used at 974, the reminder notification is displayed when the user selects a contact or enters identifying information for the entity in the third party application and input in the reminder or 3rd party application is determined at 978.

FIG. 10 depicts an example block diagram of a processing device comprising a mobile computing device for implementing the operations of the disclosed technology. Exemplary electronic circuitry of a typical mobile phone is depicted. The mobile device 1400 includes one or more microprocessors 1412, and memory 1410 (e.g., non-volatile memory such as ROM and volatile memory such as RAM) which stores processor-readable code which is executed by one or more processors of the control processor 1412 to implement the functionality described herein.

Mobile device 1400 may include, for example, processors 1412, memory 1410 including applications 1472 and non-volatile storage 1440. The processor 1412 can implement communications, as well any number of applications, including the applications discussed herein. Memory 1410 can be any variety of memory storage media types, including non-volatile and volatile memory. A device operating system handles the different operations of the mobile device 1400 and may contain user interfaces for operations, such as placing and receiving phone calls, text messaging, checking voicemail, and the like. The applications 1472 can be any assortment of programs, such as a camera application for photos and/or videos, an address book to display contact (entity) information, a calendar application, a media player, an internet browser, games, an alarm application or other third party applications. The non-volatile storage component 1440 in memory 1410 contains data such as web caches, music, photos, contact data, scheduling data, and other files. Illustrated in FIG. 10 are a reminder database 1492 including reminder data and an entity or contact database 1494 including entity records.

The processor 1412 also communicates with RF transmit/receive circuitry 1406 which in turn is coupled to an antenna 1402, with an infrared transmitted/receiver 1408, and with a movement/orientation sensor 1414 such as an accelerometer and a magnetometer 1415. A biometric sensor 1409 may be provided to access fingerprint or other biometric data Accelerometers have been incorporated into mobile devices to enable such applications as intelligent user interfaces that let users input commands through gestures, indoor GPS functionality which calculates the movement and direction of the device after contact is broken with a GPS satellite, and to detect the orientation of the device and automatically change the display from portrait to landscape when the phone is rotated. An accelerometer can be provided, e.g., by a micro-electromechanical system (MEMS) which is a tiny mechanical device (of micrometer dimensions) built onto a semiconductor chip. Acceleration direction, as well as orientation, vibration and shock can be sensed. The processor 1412 further communicates with a ringer/vibrator 1416, a user interface keypad/screen 1418, a speaker 1420, a microphone 1422, a camera 1424, a light sensor 1426 and a temperature sensor 1428. As discussed herein, the user interface keypad/screen 1418 may be a touch sensitive screen of known types. Magnetometers have been incorporated into mobile devices to enable such applications as a digital compass that measure the direction and magnitude of a magnetic field in the vicinity of the mobile device, track changes to the magnetic field and display the direction of the magnetic field to users.

The processor 1412 controls transmission and reception of wireless signals. During a transmission mode, the processor 1412 provides a voice signal from microphone 1422, or other data signal, to the transmit/receive circuitry 1406. The transmit/receive circuitry 1406 transmits the signal to a remote station (e.g., a fixed station, operator, other cellular phones, etc.) for communication through the antenna 1402. The ringer/vibrator 1416 is used to signal an incoming call, text message, calendar reminder, alarm clock reminder, or other notification to the user. During a receiving mode, the transmit/receive circuitry 1406 receives a voice or other data signal from a remote station through the antenna 1402. A received voice signal is provided to the speaker 1420 while other received data signals are also processed appropriately.

Additionally, a physical connector 1488 can be used to connect the mobile device 1400 to an external power source, such as an AC adapter or powered docking station. The physical connector 1488 can also be used as a data connection to a computing device. The data connection allows for operations such as synchronizing mobile device data with the computing data on another device. A global positioning service (GPS) receiver 1465 utilizing satellite-based radio navigation to relay the position of the user applications is enabled for such service.

Memory 1410 includes code instructing the processors 1412 to preform many of the functions described herein. For ease in understanding, the elements are represented as blocks. In addition to the applications 1472 discussed above, memory 1410 may include a number of third party application 1476 and a smart assistant 1474. The third party application 1476 may communicate with a reminder application programming interface 1478 allowing the third party applications to communicate with a reminder application 1484 which performs many of the functions illustrated in FIGS. 8-9b above. Three communication channels are illustrated: an SMS channel, an email channel and a telephone channel. The SMS and email channels receive data via any of the data interfaces illustrated in FIG. 10. As communication events for such channels are received, a polling agent 1482 monitors new inbound messages for such channels. Typically, communications on such channels do not generate events that interrupt other applications executing on a mobile device. In contract, a telephone channel 1456 typically interrupts any actions occurring in the mobile device to alert a user that an incoming phone call is occurring. As such, the interrupt from the telephone channel can be used to trigger a reminder notification. The polling agent is used to trigger reminders from events in the SMS and email channels. The reminder application 1484 interacts with system notifications 1486 which includes rules determining whether the fire an alert notification to the user interface keypad/screen 1418 based on active applications and device activity.

Nonvolatile storage 1440 includes data associated with the user including, for example, music, photos, scheduling data, calendar data, and location history. Also shown are reminder database 1492 and contact database 1494. The reminder database 1492 may be linked in a data record in a known manner to the entity or contact data records in database 1494.

It should be understood that entities may comprise a group of contacts as well as individual contacts. In this context, a group record identifying a number of entities may be stored as a record in contact database 1494 and reminder data associated with the group. In such cases, reminder data associated with the group may generate notification when communications are made to the group as a whole or when a communication with any entity who is a member of the group occurs.

In another embodiment, reminder data such as that provided in steps 802-810 of FIG. 8 can be retrieved from data associated with communications in one or more of the communication channels supported by a processing device. For example, an inbound email containing a picture attachment can include data on the subject of the picture. The data can be in the form of metadata associated with the picture (such as geo-tagging information) as well as data identifiable from the picture (such as facial recognition information). Such information can be used to populate reminder information about the entity which whom the communication is made or an entity which is the subject of the data.

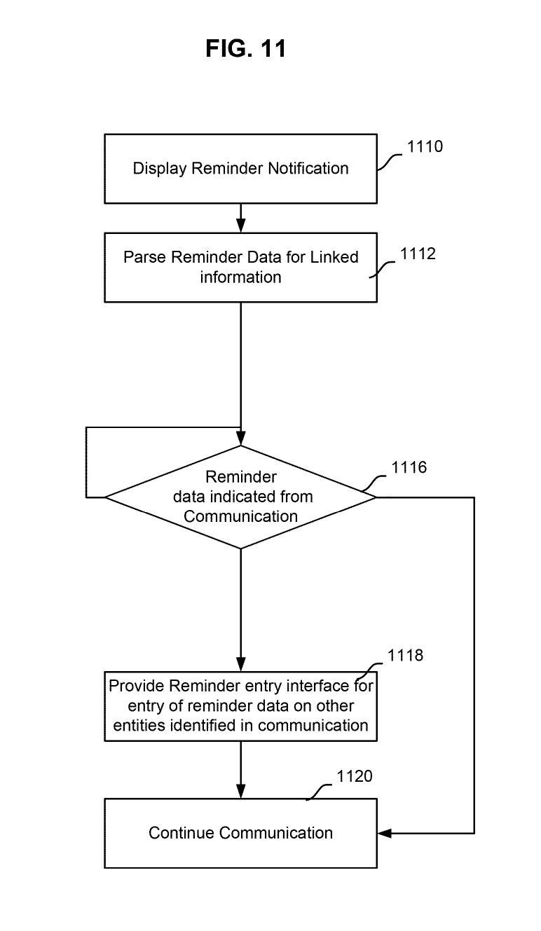

FIG. 11 is a flowchart illustrating a method of retrieving information from the subject of a communication. At 1110, a communication from a known entity is received. The communication may include additional data in the form of an attachment or data included in the communication itself which, when parsed, is used to populate reminder data. At 1112, the communication is parsed for data on all entities identifiable in the communication as well as data which may indicate a reminder should be created. For example, if the communication is an email which includes an event reminder, parties with whom the event is to take place can be included in reminder data associated with the entity information available for that contact. In another example, if a picture is received which includes a recognized entity in a communication identifying the subject of the picture was a significant event, the net information can be used to generate reminder data associated with the entity. At 1116, a determination is made as to whether or not reminder data is indicated from the communication. If no reminder data is indicated in the communication and 1120, the communication continues. If reminder data is indicated for the communication, then he reminder entry interface to allow user to enter reminder data on other entity in the communication is presented at 1118. Alternatively, information can pre-populate the reminder entry interface presented at 1118. Any of the reminder entry interface is discussed herein may be utilized at step 1118.

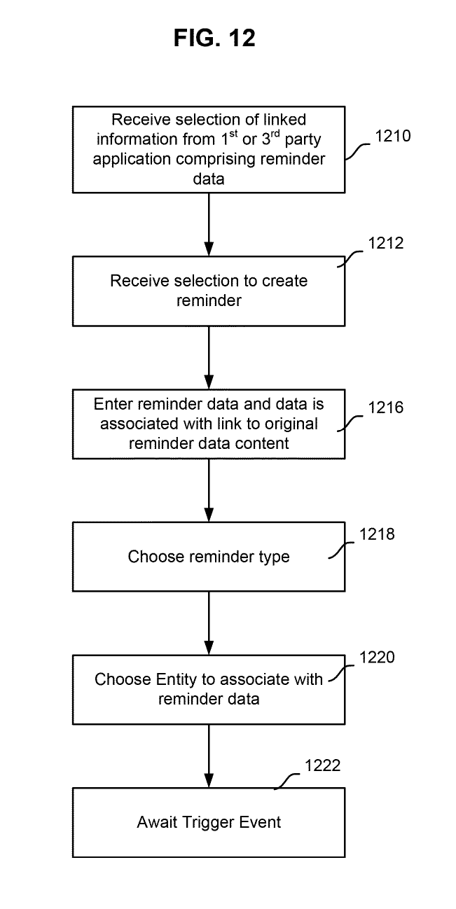

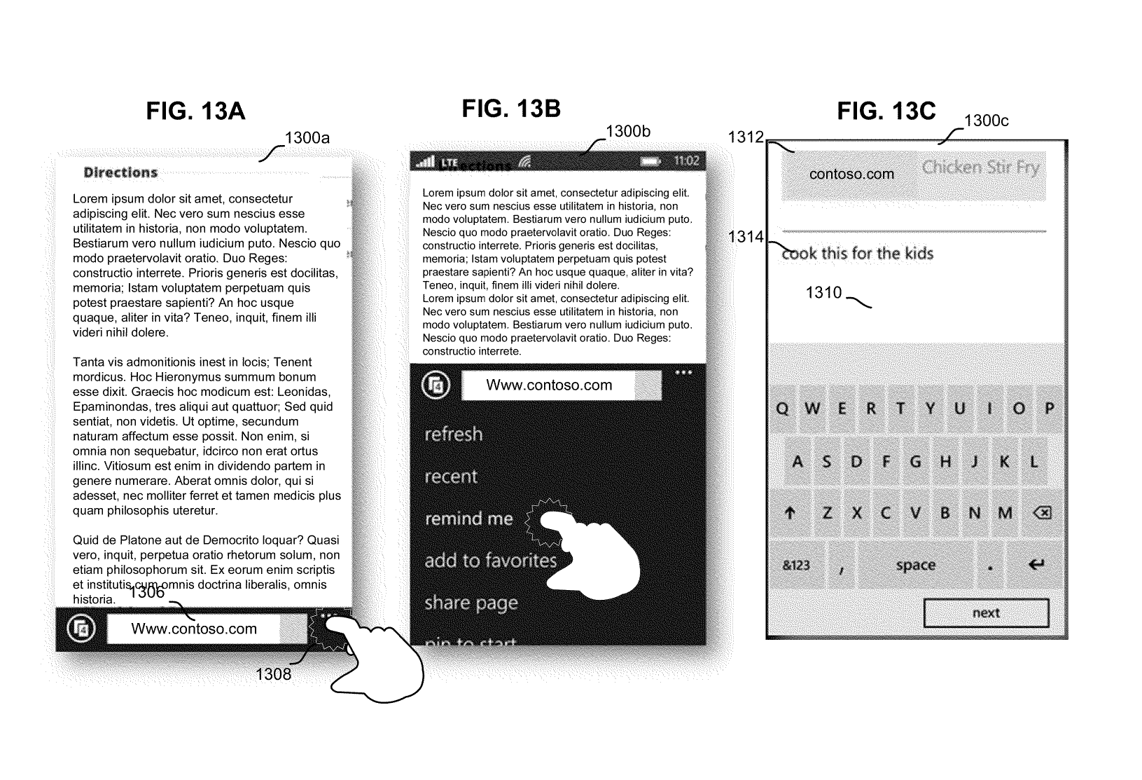

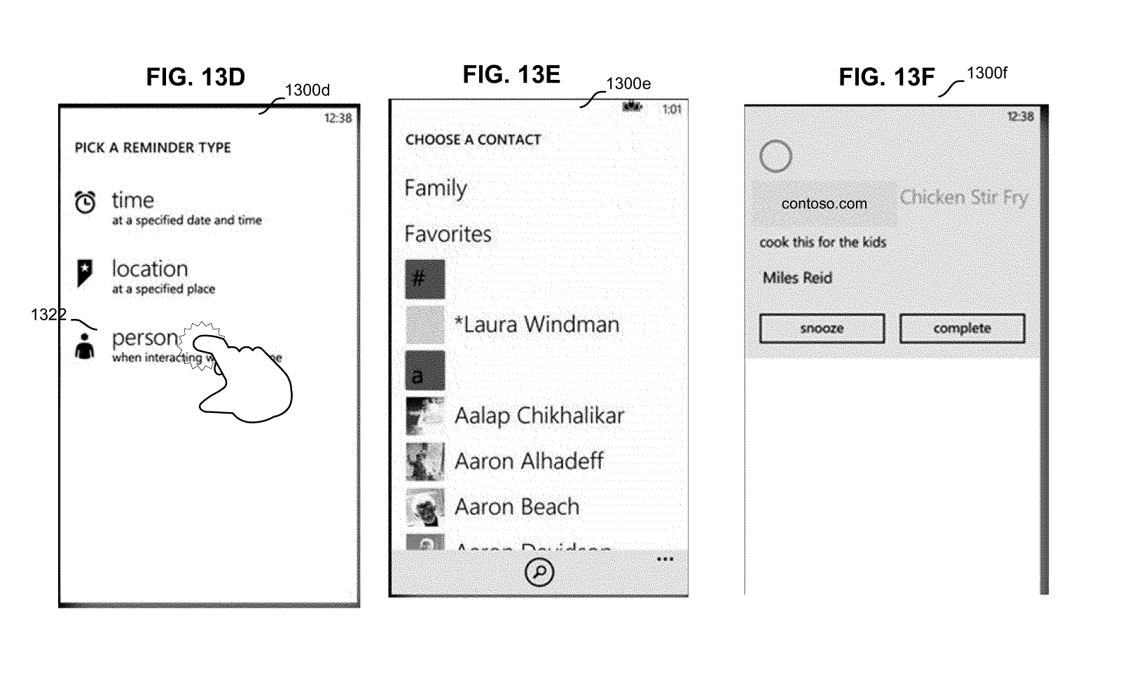

FIG. 12 is a flowchart illustrating a method of linking information from third party sources, such as web pages or other network accessible information, to an entity based reminder. FIG. 12 will be described with reference to FIGS. 13A-13F which illustrate exemplary user interfaces implementing the steps of FIG. 12. FIG. 12 may be performed by any of the processing devices illustrated herein. In general, the linked data may be displayed in a reminder notification which allows one to access the linked information upon selection of the link.

By way of example, a user of a personal computing device may utilize the device to access information available from a number of different sources such as, for example, through a web-browser on the device. An example of this type of information is shown in FIG. 13A. FIG. 13A illustrates a mobile web page www.contoso.com displaying text. Where a user may be interested in generating an entity based reminder for information at the displayed website, the user may make a selection of linked information at 1210 and select to create a reminder at step 1212. An interface 1300b allowing a user to select to create a reminder is illustrated in FIG. 13B. Interface 1300b may be provided when a user selects the interface selector 1308 in interface 1300a.

In interface 1300b, various menu items are available to the user including a “remind me” option to create a reminder. The selection of the “remind me” option as illustrated in FIG. 13B.

At 1216, any reminder data and linked information are entered. In one embodiment, the source and title of the linked data are stored with the reminder. In another embodiment, additional data may be entered by a user. An interface 1300c is shown in FIG. 13C for entering additional reminder data along with the link to the linked data. Additional data 1314 may be entered into region 1310 in interface 1300c. The linked source and title are shown at 1312.

Once the information is entered, at 1218 the reminder type is entered. An interface 1300d for selecting a reminder type is shown in FIG. 13D. As shown in FIG. 13D, an entity based reminder may be selected by touching a “person” entry on interface 1300d.

At step 1220, an entity is chosen to associate with the reminder information. An interface 1300e allowing a user to choose an entity is shown in FIG. 13E. Entities may be displayed in alphabetical order or organized by groups such as “family” and “favorites.” In a fashion similar to FIG. 13D, an entity or group may be selected by touching the entry of the entity that should be associated with the reminder.

Once the entity is selected at 1220, optionally a reminder review/confirmation screen may be displayed. Next at 1222, the method waits for a triggering event before displaying a reminder notification such as that shown in FIG. 13F. In the case of a group, interaction with any entity which is a member of the group can trigger the reminder.

Although the subject matter has been described in language specific to structural features or ink data. Methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile communication device having a plurality of communication channels, the device including a display, a processor and code instructing the processor to perform steps of:
displaying a user interface on the display, the user interface including an interaction region for a communication channel supported by the mobile communication device;
conducting a communication with a known entity via a communication channel supported by the communication device;
determining whether the known entity has at least one reminder associated with the known entity; and
responsive to the communication, displaying a reminder notification including reminder data in the user interface with data from the communication.

2. The mobile communication device of claim 1 wherein conducting the communication comprises initiating a communication with a known entity, and wherein displaying includes displaying reminder information in the user interface allowing selection of entity information to initiate the communication.

3. The mobile communication device of claim 1 wherein the reminder data includes a link to data provided by another application on the mobile device.

4. The mobile communication device of claim 3 wherein the link comprises a link to information accessible over a network which is displayed in the display on selection of the link in the reminder notification.

5. The mobile communication device of claim 1 wherein the communication channel comprises a messaging channel, a message in the messaging channel rendered in a messaging interface, and said displaying includes displaying the reminder notification when a message is received from a known entity and the messaging interface is displayed.

6. The mobile communication device of claim 5 wherein the communication channel comprises a short message service channel, and said processor includes polling the SMS channel and said displaying includes displaying the reminder notification responsive to said polling communication occurs with a known entity.

7. The mobile communication device of claim 1 wherein the communication channel is a telephone channel and the notification provided in a display area allowing the user to interact with the telephone call and the notification without disrupting the telephone call.

8. The mobile communication device of claim 7 wherein the notification is provided responsive to a user selection to display the telephone interface.

9. The mobile communication device of claim 5 wherein the messaging channel comprises an email channel, and said processor polling the email channel and said displaying includes displaying a notification including reminder datain an email message responsive to said polling.

10. The mobile communication device of claim 1 wherein the known entity comprises a group of known individuals, each individual identified by a contact record, the group identified by a group contact record.

11. A computer implemented method performed in a mobile communication device supporting a plurality of communication channels, comprising;
polling at least a subset of the communication channels to determine whether a communication event has been received on the communication channel;
conducting a communication from a known entity via a communication channel supported by the communication device, the entity having reminder data associated with the entity;
upon a communication on a subset of communication channels, determining the communication event responsive to said polling; and
displaying a reminder notification associated with the known entity including at least a portion of the reminder data in a user interface along with data from the communication, the interface showing the communication and the at least portion of the reminder data.

12. The computer implemented method of claim 11 wherein one of the plurality of communication channels not in said subset comprises a telephone channel and the communication is a telephone call, and wherein the reminder notification is provided responsive to a selection to display the telephone interface.

13. The computer implemented method of claim 12 wherein the reminder data includes a link to data provided by another application on the mobile device.

14. The computer implemented method of claim 12 wherein the subset of the communication channels comprises a messaging channel, and said displaying includes displaying a reminder notification including reminder data responsive to said polling.

15. The computer implemented method of claim 14 wherein the reminder notification is provided with reminder data in a messaging interface allowing access to the message

16. A computer implemented method in a processing device coupled to a storage device and a display, the method providing notifications based on communications received for a known entity, the communications provided on a communications channel supported by the processing device, comprising:
receiving reminder data via an interface;
associating reminder data with a known entity record stored on the storage device;
conducting a communication on a communication channel supported by the processing device, the communication channel having a communication channel user interface for the display;
determining the known entity associated with the communication;
retrieving the reminder data associated with the known entity;
determining whether a reminder notification should be displayed based on the communication channel and user interaction with the communication user interface of the processing device; and
if the communication is a message, displaying the reminder data in the communication user interface allowing the user to interact with the reminder data and message, and if the communication is a telephone call, displaying the communication user interface.

17. The computer implemented method of claim 16 wherein displaying reminder data includes displaying a user interface showing reminder data on the processing device.

18. The computer implemented method of claim 16 wherein displaying reminder data includes showing reminder data from third party applications provided on the processing device.

19. The computer implemented method of claim 16 wherein the known entity comprises a group of individuals each identified by a contact record.

20. The computer implemented method of claim 16 wherein displaying reminder data includes receiving data from a third party application and a link to additional data accessible in the third party application upon on selection of the link.
